(19) United States
(12) Patent Application Publication
(10) Pub. No.: US 2016/0103470 A1
(43) Pub. Date: Apr. 14, 2016

(54) ELECTRONIC DEVICE SYSTEM

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: RONG-RONG SONG, Wuhan (CN); DUN-JUN ZHOU, Wuhan (CN)

(21) Appl. No.: 14/527,377

(22) Filed: Oct. 29, 2014

(30) Foreign Application Priority Data
Oct. 14, 2014 (CN) 201410540919.X

(51) Int. Cl. G06F 1/18

(52) U.S. Cl. CPC G06F 1/187

(57) ABSTRACT

An electronic device system includes an enclosure with a side plate, a main board, a first hard disk drive, and a first bracket. The main board and the first bracket are located inside the enclosure. The first bracket is configured to receive the first hard disk drive. An inlet is defined in the side plate and aligned to the first bracket. The first hard disk drive is received into the first bracket via the inlet to connect to the main board.

### FIELD

The subject matter herein generally relates to electronic device systems.

### BACKGROUND

An electronic device system usually includes an enclosure and variety of electronic components, such as hard disk drive drives and power source modules, secured inside the enclosure. Before these electronic components can be installed, the enclosure must be disassembled. After installation of these electronic components, the enclosure must be assembled again.

### BRIEF DESCRIPTION OF THE DRAWINGS

Implementations of the present technology will now be described, by way of example only, with reference to the attached figures.

FIG. 1 is an exploded view of an electronic device system in an embodiment.

FIG. 2 is similar to FIG. 1, but viewed from another angle.

FIG. 3 is an enlarged view of circled portion III of FIG. 1.

FIG. 4 is a partially assembled view of the electronic device system of FIG. 1 with the first hard disk drive, the second hard disk drive, and the third hard disk drive missing.

FIG. 5 is similar to FIG. 4, but viewed from another angle.

FIG. 6 is an assembled view of the electronic device system of FIG. 1.

FIG. 7 is similar to FIG. 6, but viewed from another angle.

FIG. 8 is an enlarged view of circled portion VIII of FIG. 7.

FIG. 9 is a partially assembled view of the electronic device system of FIG. 1, showing the first hard disk drive secured in the first bracket.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to an electronic device system. The electronic device system includes an enclosure with a side plate, a main board, a first hard disk drive, and a first bracket. The main board and the first bracket are located inside the enclosure. The first bracket is configured to receive the first hard disk drive. An inlet is defined in the side plate and aligned to the first bracket. The first hard disk drive is received into the first bracket via the inlet, to connect to the main board.

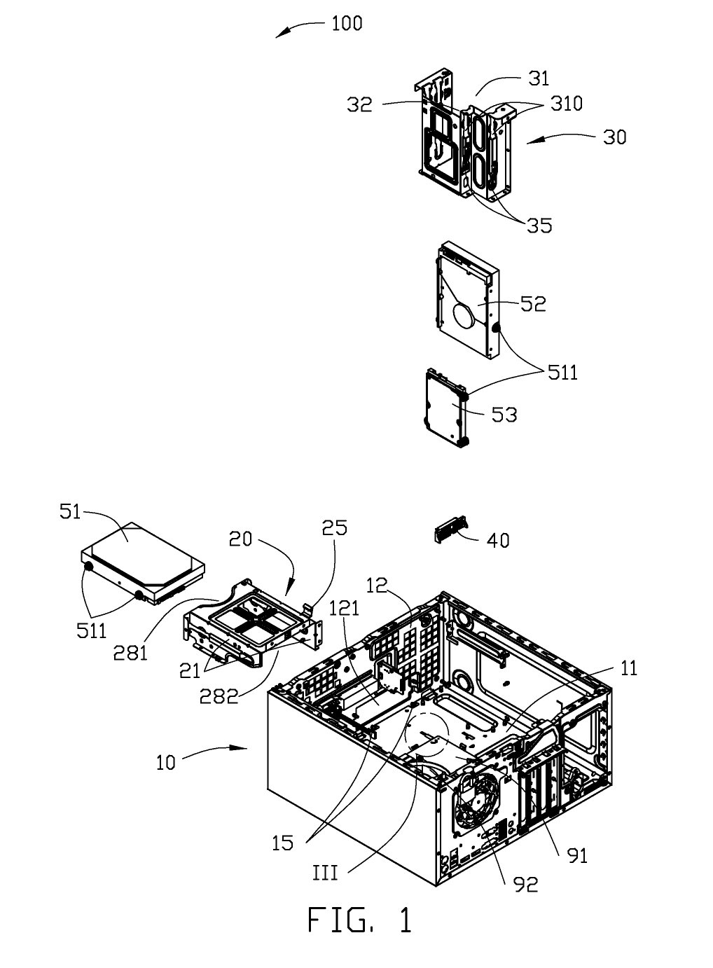

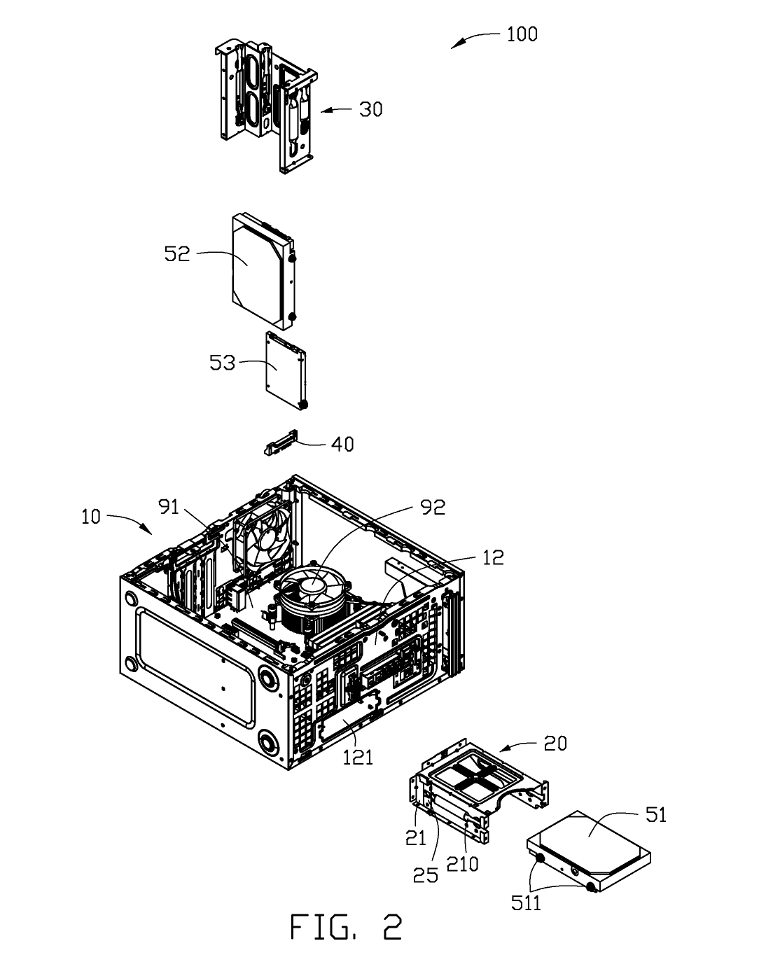

FIGS. 1-2 illustrate that an electronic device system 100 includes an enclosure 10 for housing a variety of electric components, such as a main board 91, a fan 92, a first hard disk drive 51, a second hard disk drive 52, a third hard disk drive 53, and a connector 40. The connector 40 is connected to the main board 91. In at least one embodiment, the connector 40 is a direct plug-in connector; and the electronic device system 100 is a computer system. In another embodiment, the third hard disk drive 53 is a slim hard disk drive and is smaller than the second hard disk drive 52.

The enclosure 10 includes a bottom plate 11 and a side plate 12 which perpendicularly connects to the bottom plate 11. An inlet 121 is defined in the side plate 12 and communicates with an inner space of the enclosure. The main board 91 and the fan 92 are secured inside the enclosure 10 and located at the bottom plate 11. In at least one embodiment, the main board 91 is substantially parallel with the bottom plate 11.

The electronic device system 100 further includes a first bracket 20 for receiving the first hard disk drive 51, and a second bracket 30 for receiving the second hard disk drive 52 and the third hard disk drive 53. The first bracket 20 and the second bracket 30 are located inside the enclosure 10.

FIGS. 1-2 and FIGS. 4-6 illustrate that a first side 281 of the first bracket 20 is aligned to the inlet 121 and an opposite second side 282 of the first bracket 20 is aligned to the connector 40. The connector 40 abuts the second side 282. The first hard disk drive 51 is received into the first bracket 20 via the inlet 121 along a first direction that is substantially parallel with the main board 91. The first hard disk 51 can be slid into the first bracket 20 from the first side 281 to the second side 282, until the first hard disk 51 is completely received into the first bracket 20. At this time, the first hard disk drive 51 is connected to the connector 40. Thereby the first hard disk drive 51 is connected to main board 91 via the connector 40.

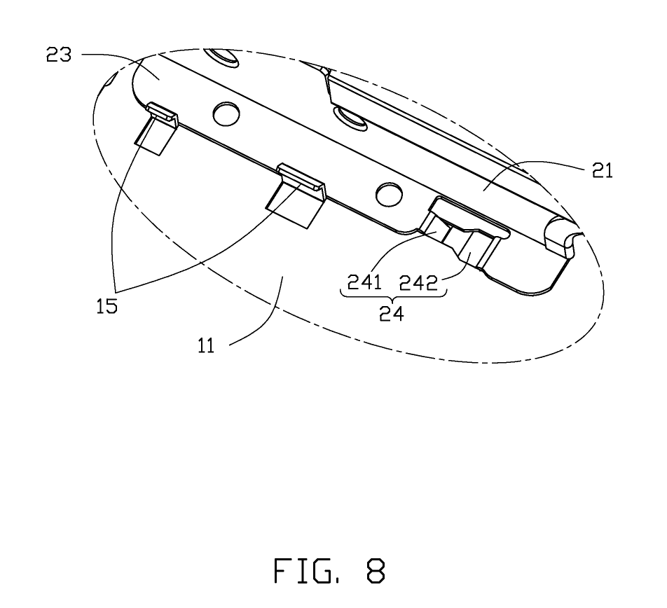

FIG. 1 and FIG. 8 illustrate that the first bracket 20 includes two parallel side walls 21. A flange 23 is connected to a bottom edge of each side wall 21 abutting the bottom plate 11 of the enclosure 10. A latch structure 24 extends from each flange 23 to be latched to the bottom plate 11. In an embodiment, the latch structure 24 is pressed out from each flange 23. Each latch structure 24 includes a first tab 241 and a second tab 242. A width of the first tab 241 is less than a width of the second tab 242. The first tab 241 and the second tab 242 are connected.

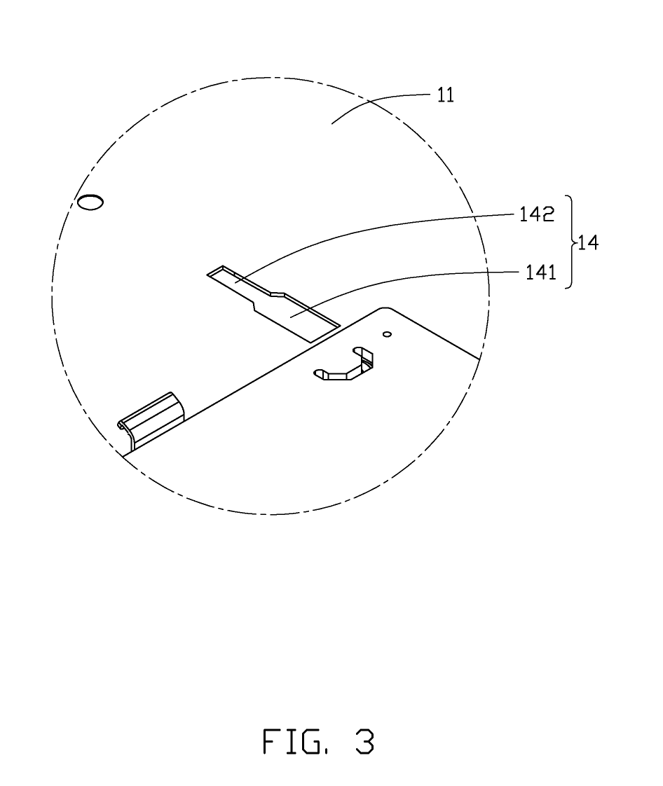

FIGS. 1-3 and FIG. 8 illustrate that a latch hole 14 is defined in the bottom plate 11 for each of the two latch structures 24. Each latch hole 14 includes a wide portion 141 and a narrow portion 142. The wide portion 141 communicates with the narrow portion 142. A width of the wide portion 141 allows the first tab 241 and the second tab 242 to pass through. A width of the narrow portion 142 allows the first tab 241 to pass through, but edges of the narrow portion 142 block and prevent the second tab 242 from passing through. Each latch structure 24 engages with each latch hole 14 and slides along the extending direction of the latch hole 14.

When the first bracket 20 is positioned at a unlocked position, each second tab 242 is aligned to the wide portion 141. Each latch structure 24 is able to freely engage with or be disengaged from each latch hole 14. When the first bracket 20 is positioned at a locked position, each second tab 242 deviates to the wide portion 141. The second tab 242 is blocked by the edges of the narrow portion 142, thereby the first bracket 20 is firmly latched to the enclosure 10.

In one embodiment, the bottom plate 11 further includes several limiting tabs 15. The limiting tabs 15 resist each flange 23, to limit the position of the first bracket 20.

The second bracket 30 includes a first portion 31 and a second portion 32. The first portion 31 is configured to receive the second hard disk drive 52, and the second portion 32 is configured to receive the third hard disk drive 53. The second hard disk drive 52 and the third hard disk drive 53 are secured into the second bracket 30 along a second direction that is substantially perpendicular to the main board 91.

FIGS. 1-2 illustrate that a plurality of mounting members 511 protrudes from each of the first hard disk drive 51, the second hard disk drive 52, and the third hard disk drive 53. A slot 210 is defined in each side wall 21 of the first bracket 20, in each side wall of the first portion 31, and in each side wall of the second portion 32. Each of the first hard disk drive 51, the second hard disk drive 52, and the third hard disk drive 53 is latched to the first bracket 20 or to the second bracket 30 while the mounting members 511 pass through the slots 210. In at least one embodiment, each mounting member 511 is a screw.

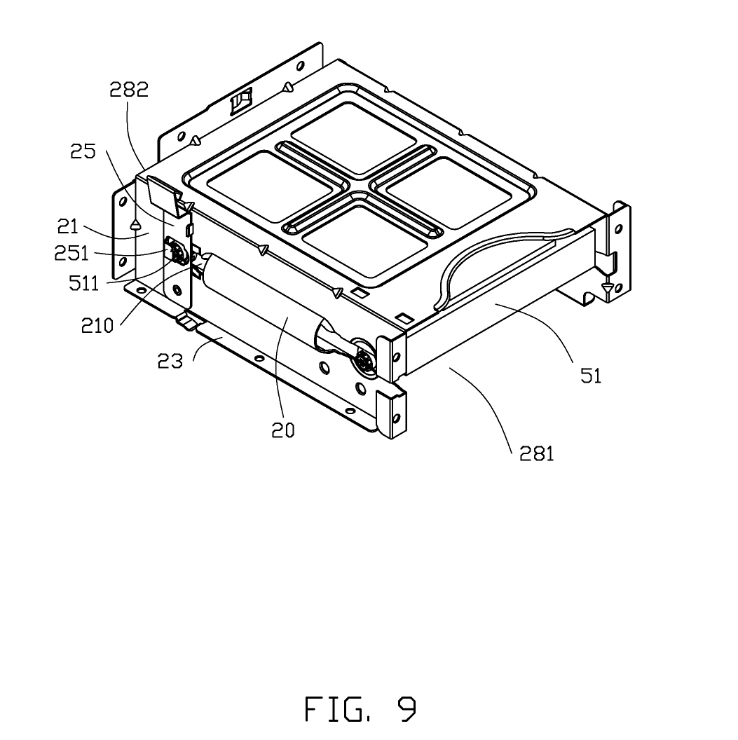

FIG. 1 and FIG. 9 illustrate that a blocking member 25 extends to the outside from the first bracket 20 for positioning the first hard disk drive 51. The blocking member 25 is located at the second side 282 of the first bracket 20. A blocking tab 251 is bent from the blocking member 25 for blocking the mounting members 511. The blocking tab 251 is aligned to each slot 210. The mounting members 511, which protrude out the first bracket 20 from the slots 20, are blocked by the blocking tabs 251. The second bracket 30 further includes at least two blocking members 35 which are the same as the blocking member 25. One of the blocking members 35 is configured to block the mounting members 511 of the second hard disk drive 52. Another of the blocking members 35 is configured to block the mounting members 511 of the third hard disk drive 53.

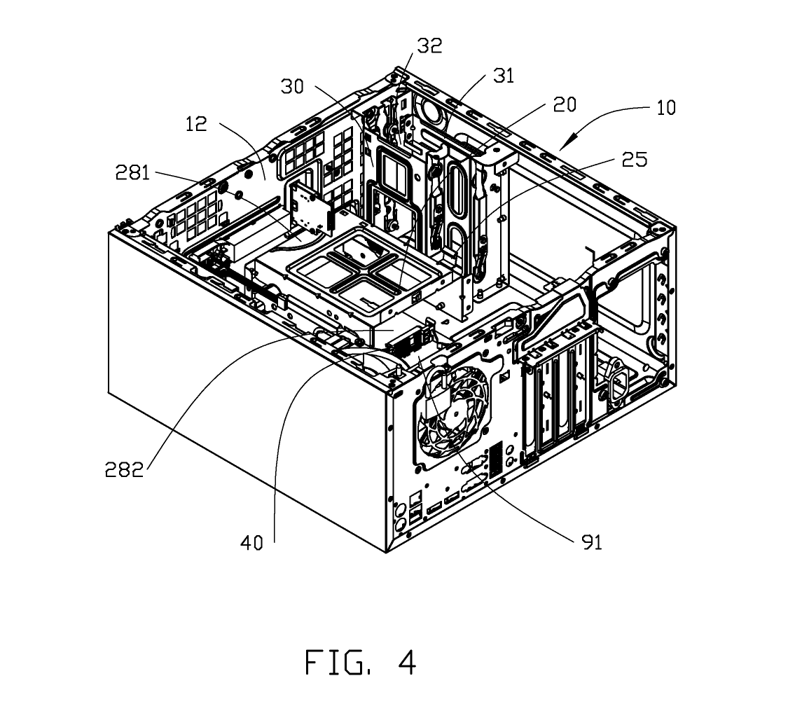

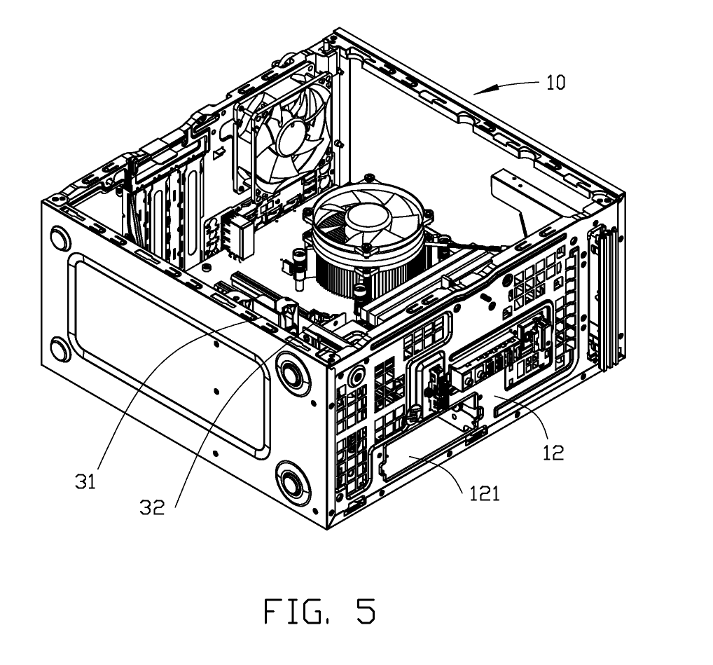

FIGS. 4-5 illustrate that, in assembly, the first bracket 20 is positioned in the enclosure 10, each flange 23 abutting the bottom plate 11. The limiting tabs 15 resist the flanges 23. The first bracket 20 is slid to the locked position and secured inside the enclosure 10. At this time, the first bracket 20 is located between the inlet 121 and the connector 40. The first side 281 of the first bracket 20 abuts the inlet 121, and the second side 282 of the first bracket 20 abuts the connector 40. The second bracket 30 is positioned in the enclosure 10 and secured by fasteners such as screws.

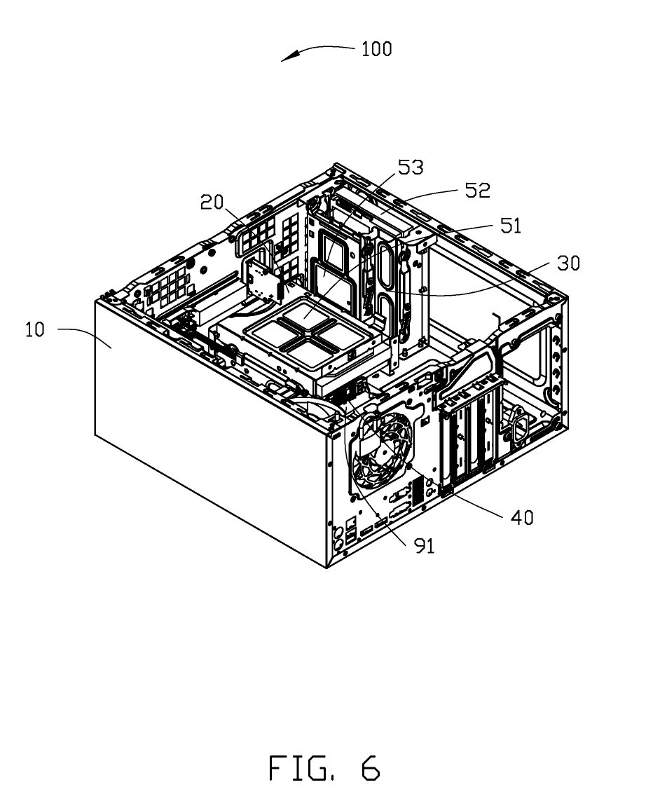

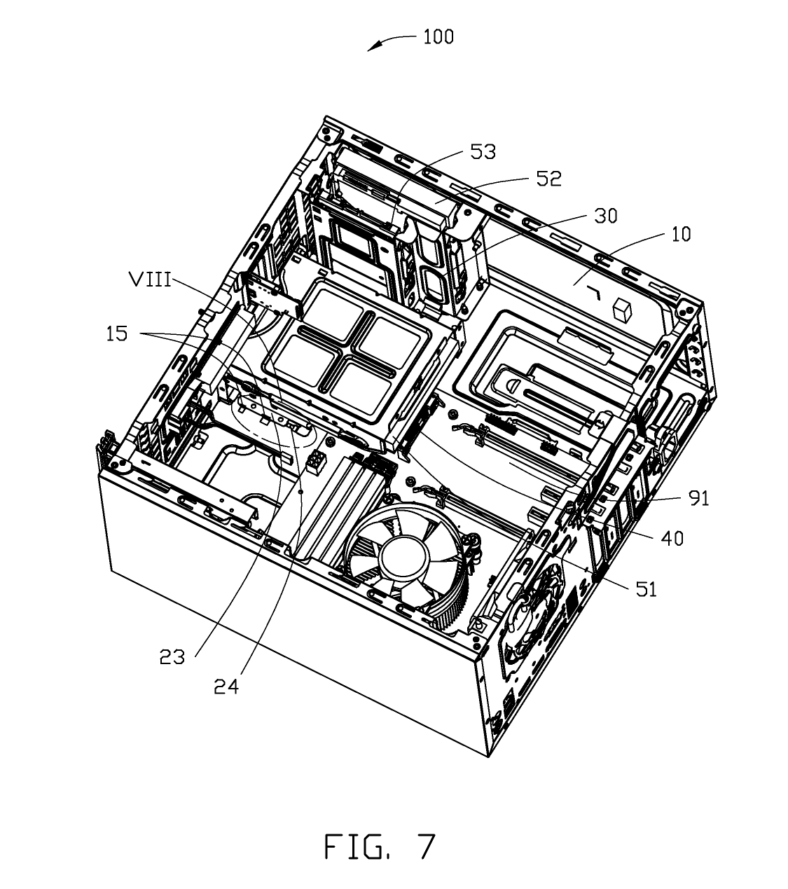

FIGS. 6-9 illustrate that the first hard disk drive 51 is received in the first bracket 20 via the inlet 121, along the first direction. The mounting members 511 of the first hard disk drive 51 pass through the slots 210 of the first bracket 20 and are blocked by the blocking member 25 of the first bracket 20. The first hard disk drive 51 is positioned at a location that is substantially parallel with the main board 91. The first hard disk drive 51 connects to the connector 40 and communicates with the main board 91 via the connector 40. The second hard disk drive 52 is received in the first portion 31 of the second bracket 30 by the mounting members 511 of the second hard disk drive 52. The third hard disk drive 53 is received in the second portion 32 of the second bracket 30 by the mounting members 511 of the third hard disk drive 53. The mounting members 511 of the second hard disk drive 52 and of the third hard disk drive 53 are blocked by the blocking members 35 of the second bracket 30. The second hard disk drive 52 and the third hard disk drive 53 are positioned at a location that is substantially perpendicular to the main board 91.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An electronic device system comprising:
an enclosure with a side plate;
an inlet defined in the side plate;
a main board located inside the enclosure;
a connector connecting to the main board; and
a first bracket secured inside the enclosure;
wherein the first bracket is configured to receive a first hard disk drive via the inlet, and the connector is configured to connect the first hard disk drive to the main board.

2. The electronic device system of claim 1, wherein when the first hard disk drive is received into the first bracket, the first hard disk drive is connected to the connector.

3. The electronic device system of claim 1, wherein one side of the first bracket is aligned to the inlet, an opposite side of the first bracket is aligned to the connector.

4. The electronic device system of claim 1, wherein the connector is a direct plug-in connector.

5. The electronic device system of claim 1, wherein the first hard disk drive is secured into the first bracket along a first direction substantially parallel with the main board.

6. The electronic device system of claim 1, wherein the first bracket comprises a flange abutting the enclosure, and a latch structure extends from the flange to latch the enclosure.

7. The electronic device system of claim 6, wherein a latch hole is defined in the enclosure for the latch structure, and the latch structure is engaged with the latch hole to position the first bracket to the enclosure.

8. The electronic device system of claim 7, wherein the latch hole comprises a wide portion and a narrow portion, the latch structure passes through the wide portion and is blocked by edges of the narrow portion.

9. The electronic device system of claim 1, wherein a blocking member extends outside from the first bracket for positioning the first hard disk drive, and a mounting member protrudes from the first hard disk drive and is blocked by the blocking member.

10. The electronic device system of claim 1 further comprising a second bracket located inside the enclosure for receiving a second hard disk drive; wherein the second hard disk drive is secured into the second bracket along a second direction substantially perpendicular to the main board.

11. An electronic device system comprising:
an enclosure;
a main board located inside the enclosure;
a first bracket secured inside the enclosure for receiving a first hard disk drive; and
a second bracket secured inside the enclosure for receiving a second hard disk drive;
wherein the first hard disk drive is secured into the first bracket along a first direction, the second hard disk drive is secured into the second bracket along a second direction that is substantially perpendicular to the first direction.

12. The electronic device system of claim 11, wherein the first direction is substantially parallel with the main board, and the second direction is substantially perpendicular to the main board.

13. The electronic device system of claim 11, wherein the second bracket comprises a first portion and a second portion, the first portion is configured to receive the second hard disk drive, the second portion is configured to receive a third hard disk drive which is smaller than the second hard disk drive.

14. The electronic device system of claim 11, wherein the enclosure comprises a side plate, an inlet is defined in the side plate and aligned to the first bracket, the first hard disk drive is received into the first bracket via the inlet.

15. The electronic device system of claim 14 further comprising a connector connecting to the main board, wherein when the first hard disk drive is received into the first bracket, the first hard disk drive is connected to the main board via the connector.

16. The electronic device system of claim 15, wherein the connector is a direct plug-in connector.

17. The electronic device system of claim 11, wherein the first bracket comprises a flange abutting the enclosure, a latch structure extends from the flange to latch the enclosure.

18. The electronic device system of claim 17, wherein a latch hole is defined in the enclosure for the latch structure, the latch structure is engaged with the latch hole to position the first bracket to the enclosure.

19. The electronic device system of claim 17, wherein a limiting tab extends from the enclosure for resisting the flange of the first bracket.

20. The electronic device system of claim 11, wherein a blocking member extends outside from the first bracket for positioning the first hard disk drive, and a mounting member protrudes from the first hard disk drive and is blocked by the blocking member.
